(19) United States
(12) Patent Application Publication
(10) Pub. No.: US 2025/0139341 A1
(43) Pub. Date: May 1, 2025

(54) HIGH-LEVEL SYNTHESIS APPARATUS

(71) Applicant: NEC Corporation, Tokyo (JP)

(72) Inventor: Wataru TAKAHASHI, Tokyo (JP)

(73) Assignee: NEC Corporation, Tokyo (JP)

(21) Appl. No.: 18/918,257

(22) Filed: Oct. 17, 2024

(30) Foreign Application Priority Data
Nov. 1, 2023 (JP) 2023-187935

(51) Int. Cl. G06F 30/327; G06F 119/02

(52) U.S. Cl. CPC G06F 30/327; G06F 2119/02

(57) ABSTRACT

A high-level synthesis apparatus generating a circuit description in response to input of a behavioral description describing the behavior of a circuit includes: a hazard detection circuit adding unit that adds a hazard detection circuit determining the presence or absence of occurrence of hazard to a pipeline circuit generated in accordance with the behavioral description; and a circuit description generating unit that generates the circuit description describing the pipeline circuit with the hazard detection circuit added by the hazard detection circuit adding unit.

### INCORPORATION BY REFERENCE

This application is based upon and claims the benefit of priority from Japanese patent application No. 2023-187935, filed on Nov. 1, 2023, the disclosure of which is incorporated herein in its entirety by reference.

### TECHNICAL FIELD

The present disclosure relates to a high-level synthesis apparatus, a high-level synthesis method, and a recording medium.

### BACKGROUND ART

A high-level synthesis system is known that generates a circuit description such as an RTL (Register-transfer level) description from a behavioral description that describes the behavior of a circuit.

For example, Patent Literature 1 describes a high-level synthesis apparatus that performs a high-level synthesis process on a behavioral description that describes the behavior of a circuit and outputs a hardware description language that operates the circuit. For example, the high-level synthesis apparatus includes a CDFG (control data flow graph) changing unit that acquires, as a first CDFG, a CDFG representing an iterative operation process of repeatedly executing operation processes with the output of an operation process as the input of a subsequent operation process, and that changes the first CDFG to a second CDFG of executing the iterative operation process represented by the first CDFG through pipeline processing. The high-level synthesis apparatus also includes: a scheduling unit that outputs a scheduling result of a case of executing the iterative operation process represented in the first CDFG through pipeline processing; and a pipeline determining unit that determines whether or not the iterative operation process represented in the first CDFG can be performed through pipeline processing based on the scheduling result. Then, the CDFG changing unit changes the first CDFG to the second CDFG in a case where the pipeline determining unit determines that the iterative operation process represented in the first CDFG can be performed through pipeline processing.

Further, a related technique is described in Patent Literature 2. Patent Literature 2 describes a high-level synthesis apparatus that determines a countermeasure method for resolving a hazard so as to correctly operate a pipelined circuit. According to Patent Literature 2, the high-level synthesis apparatus includes: a data hazard detecting unit that detects a location in a behavioral description where a data hazard has occurred as a data hazard location; and a countermeasure determining unit. The countermeasure determining unit determines one of the following methods as a countermeasure method for resolving the data hazard at the data hazard location based on a performance estimation value that is an estimation value of circuit performance including circuit latency and circuit size; a method of reducing the pipelining performance of the circuit, a method of reducing the operating frequency of the data hazard location, and a method in combination of the method of reducing the pipelining performance of the circuit and the method of reducing the operating frequency of the data hazard location.
Patent Literature 1: Japanese Patent Publication No. 6246445
Patent Literature 2: Japanese Patent Publication No. 6735951

The techniques described in Patent Literatures 1 and 2 do not assume an array to be allocated to memory. Therefore, in the case of using the techniques described in Patent Literatures 1 and 2, it is not possible to know, when a subscript in an array is a variable, which element will be accessed unless a simulation is actually performed, and as a result, such a variable may be excessively regarded as a data hazard variable. Thus, a problem has arisen in that it may be difficult to properly detect a hazard when performing high-level synthesis.

### SUMMARY OF THE INVENTION

Accordingly, an object of the present disclosure is to provide a high-level synthesis apparatus, a high-level synthesis method and a program that can solve the abovementioned problem.

In order to achieve the object, a high-level synthesis apparatus in the present disclosure is a high-level synthesis apparatus generating a circuit description in response to input of a behavioral description describing a behavior of a circuit, and the high-level synthesis apparatus includes: a hazard detection circuit adding unit that adds a hazard detection circuit determining presence or absence of occurrence of hazard to a pipeline circuit generated in accordance with the behavioral description; and a circuit description generating unit that generates the circuit description describing the pipeline circuit with the hazard detection circuit added by the hazard detection circuit adding unit.

Further, a high-level synthesis method in the present disclosure is a high-level synthesis method by an information processing apparatus generating a circuit description in response to input of a behavioral description describing a behavior of a circuit, and the high-level synthesis method includes: adding a hazard detection circuit determining presence or absence of occurrence of hazard to a pipeline circuit generated in accordance with the behavioral description; and generating the circuit description describing the pipeline circuit with the hazard detection circuit added.

Further, a computer program in the present disclosure includes instructions for causing an information processing apparatus, which generates a circuit description in response to input of a behavioral description describing a behavior of a circuit, to execute processes to: add a hazard detection circuit determining presence or absence of occurrence of hazard to a pipeline circuit generated in accordance with the behavioral description; and generate the circuit description describing the pipeline circuit with the hazard detection circuit added.

With the configurations as described above, it is possible to more properly detect a hazard in the case of performing high-level synthesis.

### BRIEF DESCRIPTION OF DRAWINGS

FIG. 1 is a view showing the overview of a high-level synthesis apparatus in the present disclosure;

FIG. 2 is a block diagram showing an example of the configuration of the high-level synthesis apparatus;

FIG. 3 is a view showing an example of pipeline processing;

FIG. 4 is a view for describing an example of a hazard detection circuit;

FIG. 5 is a view showing an example of a process to stall pipeline processing;

FIG. 6 is a flowchart showing an example of the operation at the time of generating a circuit description;

FIG. 7 is a flowchart showing an example of the operation in hazard detection;

FIG. 8 is a view showing an example of the hardware configuration of a second high-level synthesis apparatus in the present disclosure;

FIG. 9 is a block diagram showing an example of the configuration of the high-level synthesis apparatus; and

FIG. 10 is a flowchart showing an example of the operation of the high-level synthesis apparatus.

### EXAMPLE EMBODIMENT

### First Example Embodiment

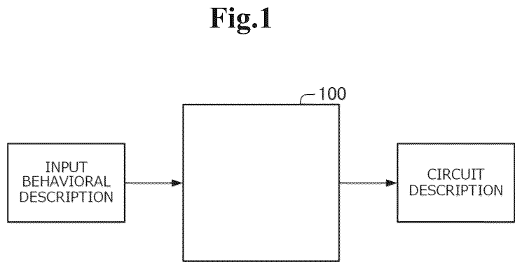

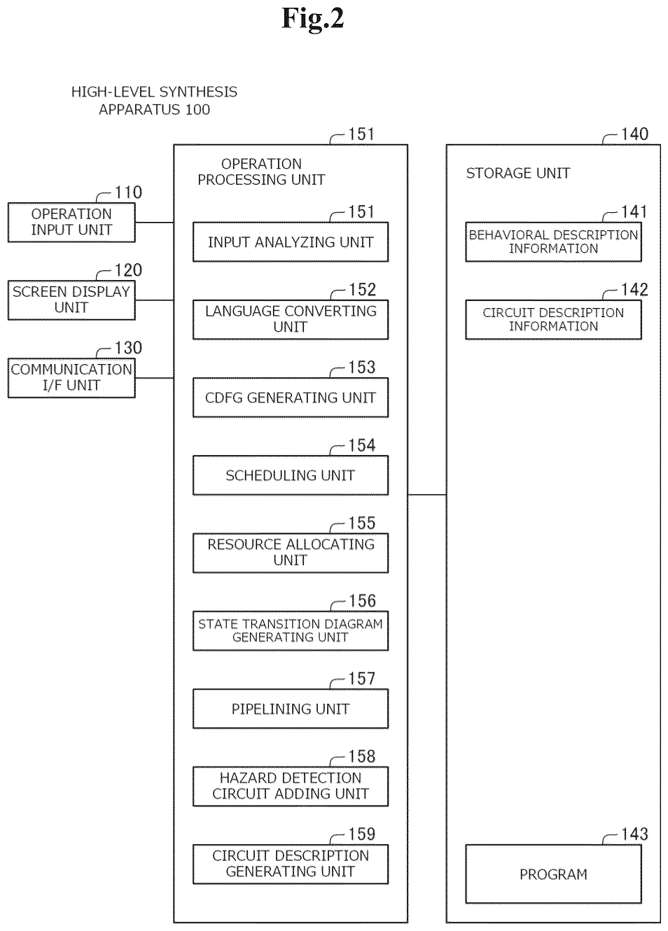

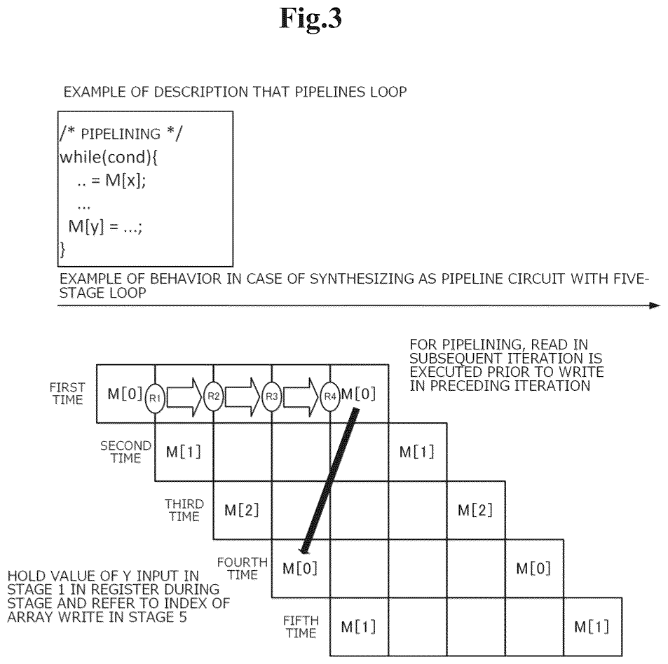

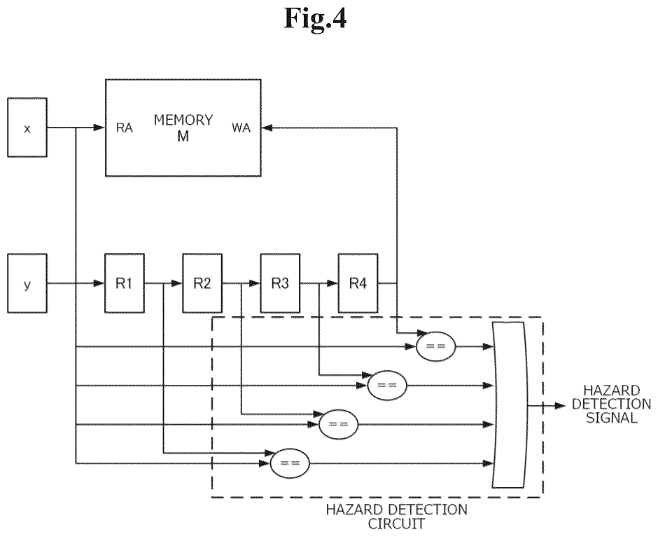

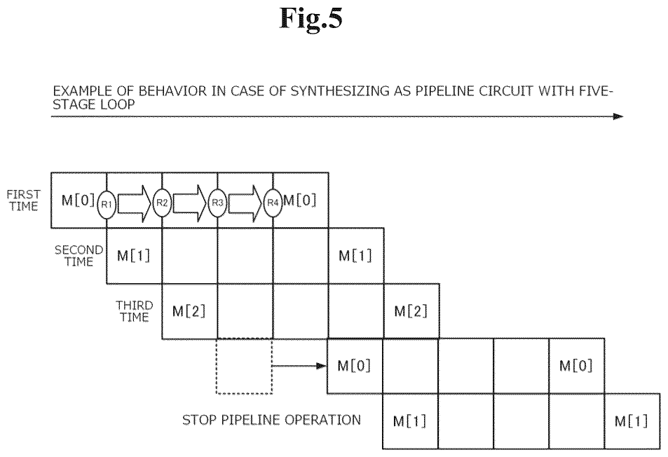

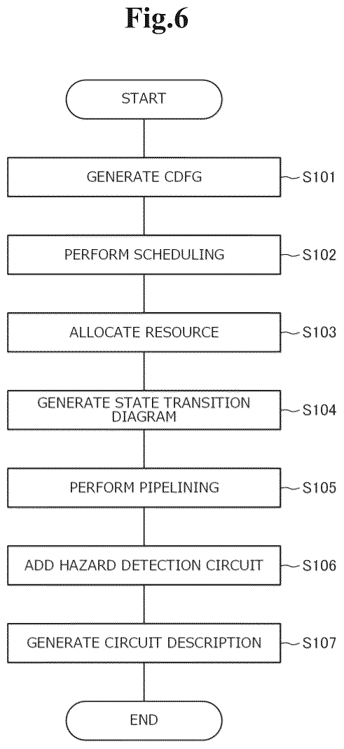

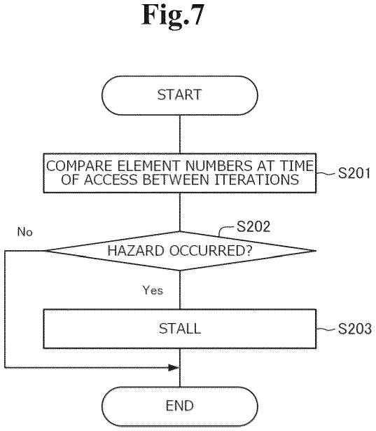

An example of the configuration of a high-level synthesis apparatus 100 according to the present disclosure will be described with reference to FIGS. 1 to 7. FIG. 1 is a view showing the overview of the high-level synthesis apparatus 100. FIG. 2 is a block diagram showing an example of the configuration of the high-level synthesis apparatus 100. FIG. 3 is a view showing an example of pipeline processing. FIG. 4 is a view for describing an example of a hazard detection circuit. FIG. 5 is a view showing an example of a process to stall pipeline processing. FIG. 6 is a flowchart showing an example of the operation at the time of generating a circuit description. FIG. 7 is a flowchart showing an example of the operation in hazard detection. In the present disclosure, the drawings may be associated with one or more example embodiments.

In a first example embodiment of the present disclosure, the high-level synthesis apparatus 100 will be described that performs a high-level synthesis process in response to input of a behavioral description describing the behavior of a circuit and thereby generates a circuit description, which is a hardware description language for operating the circuit, as shown in FIG. 1. As will be described later, the high-level synthesis apparatus 100 generates a pipeline circuit in accordance with the behavioral description, and adds a hazard detection circuit that determines whether or not a hazard has occurred to the pipeline circuit. Then, the high-level synthesis apparatus 100 outputs a circuit description that describes a pipeline circuit with the hazard detection circuit added. This allows the high-level synthesis apparatus 100 to dynamically perform hazard detection using the added hazard detection circuit during RTL (Register-transfer level) simulation and the like.

Further, as will be described below, the high-level synthesis apparatus 100 can provide the hazard detection circuit with functions such as stalling (stopping) a pipelining operation when a hazard is detected and displaying the fact that a hazard has been detected. In other words, the high-level synthesis apparatus 100 can add the hazard detection circuit having a function of controlling the pipelining operation according to the result of hazard detection to the pipeline circuit. In addition, the high-level synthesis apparatus 100 may be configured so as to be capable of controlling whether or not to add the hazard detection circuit in response to, for example, an instruction from an operator who operates the high-level synthesis apparatus 100.

In the present disclosure, there is no particular limitation on, for example, the type of a circuit description that the high-level synthesis apparatus 100 generates according to the behavioral description. For example, the high-level synthesis apparatus 100 may generate an RTL description such as Verilog or VHDL (VHSIC Hardware Description Language), or may generate a cycle model description. The high-level synthesis apparatus 100 may generate any of the circuit descriptions illustrated above, or may generate some of them. In addition, the behavioral description input to the high-level synthesis apparatus 100 may be source code that describes the behavior of a circuit to be subjected to high-level synthesis in a high-level language such as C or C++.

FIG. 2 shows an example of the configuration of the high-level synthesis apparatus 100. Referring to FIG. 2, the high-level synthesis apparatus 100 has, as main components, for example, an operation input unit 110, a screen display unit 120, a communication I/F unit 130, a storage unit 140, and an operation processing unit 150.

FIG. 2 illustrates a case of realizing a function as the high-level synthesis apparatus 100 using one information processing apparatus. However, at least part of the function as the high-level synthesis apparatus 100 may be realized using a plurality of information processing apparatuses, for example, may be realized on the cloud. Moreover, the high-level synthesis apparatus 100 may not include some of the components illustrated above, such as not having the operation input unit 110 or the screen display unit 120, or may have components other than those illustrated above.

The operation input unit 110 includes operation input devices such as a keyboard and a mouse. The operation input unit 110 detects an operation by an operator operating the high-level synthesis apparatus 100 and outputs to the operation processing unit 150.

The screen display unit 120 includes a screen display device such as a liquid crystal display or an organic EL (electro-luminescence) display. The screen display unit 120 can display on the screen various types of information stored in the storage unit 140 in response to an instruction from the operation processing unit 150.

The communication I/F unit 130 includes a data communication circuit and the like. The communication I/F unit 130 performs data communication with an external device connected via a communication line.

The storage unit 140 is a storage device such as a hard disk and a memory. The storage unit 140 stores processing information necessary for a variety of processing in the operation processing unit 150 and a program 143. The program 143 is read into the operation processing unit 150 and executed to realize various processing units. The program 143 is read in advance from an external device or a recording medium via a data input/output function such as the communication I/F unit 130 and is stored in the storage unit 140. Main information stored in the storage unit 140 includes, for example, behavioral description information 141 and circuit description information 142.

The behavioral description information 141 includes source code, which is a behavioral description that describes the behavior of a circuit to be subjected to high-level synthesis in a high-level language such as C or C++. The behavioral description information 141 is acquired in advance by a method such as receiving from an external device via the communication I/F unit 130 or accepting input using the operation input unit 110, and is stored in the storage unit 140.

The circuit description information 142 includes an RTL description, a cycle model description or the like that describes the structure of a circuit such as a pipeline circuit. As will be described later, in the case of the present disclosure, a circuit to be described by an RTL description or the like includes, in addition to a pipeline circuit, a hazard detection circuit that determines whether or not a hazard has occurred. The circuit description information 142 is updated in response to generation of a circuit description by a circuit description generating unit 159 to be described later.

The operation processing unit 150 has an arithmetic logic unit such as a CPU (Central Processing Unit) and a peripheral circuit thereof. The operation processing unit 150 reads the program 143 from the storage unit 140 and executes the program 143 to realize various processing units by making the above hardware and the program 143 cooperate. Main processing units realized in the operation processing unit 150 include, for example, an input analyzing unit 151, a language converting unit 152, a CDFG (control data flow graph) generating unit 153, a scheduling unit 154, a resource allocating unit 155, a state transition diagram generating unit 156, a pipelining unit 157, a hazard detection circuit adding unit 158, and a circuit description generating unit 159.

In addition, the operation processing unit 150 may have, instead of the abovementioned CPU, a GPU (Graphics Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof.

The input analyzing unit 151 performs syntax analysis or the like in accordance with the source code included in the behavioral description information 141. The language converting unit 152 performs necessary language conversion in accordance with the result of the syntax analysis.

The CDFG generating unit 153 generates a CDFG (control data flow graph), which is a graph representing the flow of data and control, according to the result of the analysis by the input analyzing unit 151 and the result of the conversion by the language converting unit 152. The CDFG generating unit 153 may generate the CDFG by a general method.

The scheduling unit 154 determines a control cycle that indicates what to do in what state, and the like, according to the CDFG. The scheduling unit 154 may determine the control cycle using information such as a predetermined clock frequency.

The resource allocating unit 155 allocates a resource for executing each operation based on the control cycle determined by the scheduling unit 154. In other words, the resource allocating unit 155 allocates hardware resources in accordance with the result of the determination by the scheduling unit 154.

The state transition diagram generating unit 156 generates a state transition diagram showing how the state determined by the scheduling unit 154 transitions. The pipelining unit 157 performs pipelining by convolving a plurality of states into one. The operation of the state transition diagram generating unit 156 and the operation of the pipelining unit 157 may be executed in any order or may be executed in parallel.

For example, by using the processing units as described above, the high-level synthesis apparatus 100 generates a pipeline circuit in accordance with source code that is a behavioral description.

The hazard detection circuit adding unit 158 adds a hazard detection circuit that determines whether a hazard has occurred to the pipeline circuit as illustrated above. By adding the hazard detection circuit, the occurrence of a hazard can be dynamically detected during a simulation or the like.

Here, the hazard detection circuit is, for example, a circuit that dynamically determines the presence or absence of a hazard by comparing element numbers at the time of access between iterations during execution of an RTL simulation or the like. In other words, the hazard detection circuit determines whether or not a hazard has occurred by checking whether or not the register value of the element number of each stage is the same as the element number in the above array on the description.

FIG. 3 shows an example of operation during a simulation in a case where a pipeline circuit with a five-stage loop is synthesized. For example, in the example shown in FIG. 3, the next iteration starts every cycle. Also, referring to FIG. 3, the element numbers of the first iteration and the fourth iteration are [0]. Then, prior to write performed in the fifth stage of the first iteration that is the preceding iteration, read in the fourth iteration is performed. Therefore, in the example shown in FIG. 3, in the fourth cycle, read in the subsequent iteration is performed prior to write in the preceding iteration. In this case, in the hazard detection circuit, register R3 and memory [0] match, and a hazard detection signal is transmitted. That is to say, the hazard detection circuit detects the occurrence of a hazard.

FIG. 4 shows a specific example of the configuration of the hazard detection circuit added by the hazard detection circuit adding unit 158 in the case illustrated in FIG. 3. For example, with a configuration as shown in FIG. 4, the hazard detection circuit can determine the presence or absence of a hazard by checking whether or not the register value of the element number of each stage is the same as the element number in the above array on the description.

In addition, the hazard detection circuit adding unit 158 may be configured to provide the hazard detection circuit with functions such as stalling (stopping) a pipeline operation when a hazard is detected and displaying the fact that a hazard is detected, in addition to determining whether or not a hazard has occurred. In other words, the hazard detection circuit adding unit 158 may add a control circuit that stalls the pipeline operation in accordance with the result of the hazard detection, in addition to the circuit that determines whether or not a hazard has occurred.

For example, FIG. 5 shows an example of a case of stalling the pipeline operation. As shown in FIG. 5, upon detection of the occurrence of a hazard, the hazard detection circuit can stop the pipeline operation until the hazard is resolved. As an example, the hazard detection circuit can be configured to, upon detection of a hazard, stop whole execution of the iteration causing the hazard and later iterations until array access of the iteration in which the hazard has been detected is completed. For example, in the example shown in FIG. 5, the hazard detection circuit stops execution of the fourth and subsequent iterations until the first iteration in which a hazard has been detected is completed.

Further, the hazard detection circuit may be configured to, upon detection of the occurrence of a hazard, display the fact that the hazard has been detected on the screen display unit 120 or transmit to an external device via the communication I/F unit 130. The hazard detection circuit may be configured to output, in addition to the fact that the hazard has been detected, information indicating the cause of the hazard, such as the element number or iteration information in which the hazard has occurred. The hazard detection circuit may also be configured to count the number of occurrences of hazards.

The circuit description generating unit 159 generates a circuit description describing a pipeline circuit with the hazard detection circuit added. Moreover, the circuit description generating unit 159 stores the generated circuit description as the circuit description information 142 into the storage unit 140. As described above, the circuit description generating unit 159 may generate an RTL description as the circuit description, or may generate a cycle model description or the like.

The above is an example of the configuration of the high-level synthesis apparatus 100.

Next, an example of the operation of the high-level synthesis apparatus 100 will be described with reference to FIGS. 6 and 7. First, an example of operation for generating a circuit description will be described with reference to FIG. 6.

Referring to FIG. 6, the CDFG generating unit 153 generates a CDFG in accordance with the source code included in the behavioral description information 141 (step S101). The CDFG generating unit 153 may generate a CDFG (control data flow graph) in accordance with the result of analysis by the input analyzing unit 151 for the source code and the result of conversion by the language converting unit 152.

The scheduling unit 154 determines a control cycle showing what to do in what state, and the like, according to the CDFG (step S102). The scheduling unit 154 may determine the control cycle using information such as a predetermined clock frequency.

The resource allocating unit 155 allocates a resource for executing each operation based on the control cycle determined by the scheduling unit 154 (step S103).

The state transition diagram generating unit 156 generates a state transition diagram showing how the state determined by the scheduling unit 154 transitions (step S104). Moreover, the pipelining unit 157 performs pipelining by convolving a plurality of states into one (step S105). The operation at step S104 and the operation at step S105 may be performed in any order or may be performed in parallel.

The hazard detection circuit adding unit 158 adds a hazard detection circuit that determines whether or not a hazard has occurred to the pipeline circuit as illustrated above (step S106). By adding the hazard detection circuit, it is possible to dynamically detect the occurrence of a hazard during a simulation or the like.

The circuit description generating unit 159 generates a circuit description describing the pipeline circuit with the hazard detection circuit added (step S107). The circuit description generating unit 159 may generate an RTL description as the circuit description, or may generate a cycle model description or the like.

The above is an example of the operation when generating a circuit description. Next, an example of operation in hazard detection will be described with reference to FIG. 7.

Referring to FIG. 7, during execution such as during a simulation, the hazard detection circuit dynamically determines the presence or absence of a hazard by comparing element numbers at the time of access between iterations (step S201). In other words, the hazard detection circuit determines whether or not a hazard has occurred by checking whether the register value of the element number of each stage is the same as the element number in the above array on the description.

In a case where a hazard has occurred (step S202, Yes), the hazard detection circuit can stall the pipeline operation (step S203). On the other hand, in a case where a hazard has not occurred (step S202, No), the hazard detection circuit does not perform the control at step S203.

The above is an example of the operation in hazard detection.

Thus, the high-level synthesis apparatus 100 has the hazard detection circuit adding unit 158 and the circuit description generating unit 159. With such a configuration, the circuit description generating unit 159 can generate a circuit description that describes a pipeline circuit with a hazard detection circuit added. As a result, a hazard can be dynamically detected during an RTL simulation and the like. This makes it possible to realize proper hazard detection.

Further, the hazard detection circuit adding unit 158 can provide the hazard detection circuit with a function of stalling (stopping) the pipeline operation when a hazard is detected, in addition to determining whether or not a hazard has occurred. With such a configuration, when the hazard detection circuit dynamically detects a hazard, it is possible to stall the pipeline operation. Consequently, for example, it is possible to prevent the value of an output that is the result of the simulation and the like from differing from an expected value due to a hazard. As a result, the time required for design verification can be reduced.

Further, the hazard detection circuit adding unit 158 can provide the hazard detection circuit with a function of displaying the fact that a hazard has been detected, in addition to determining whether or not a hazard has occurred. Consequently, it is possible to accurately inform the operator or the like that a hazard has occurred.

### Second Example Embodiment

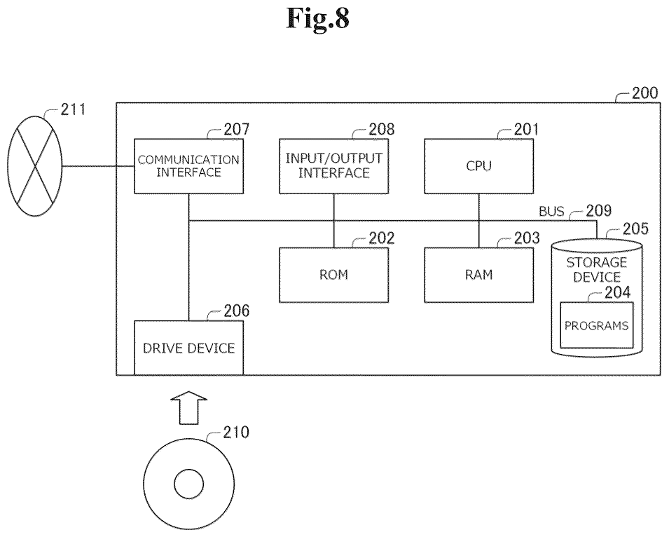

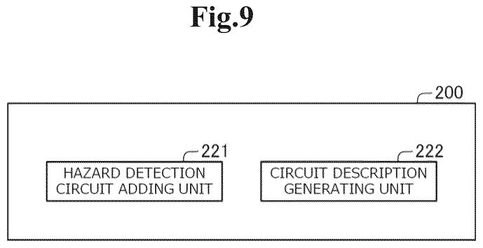

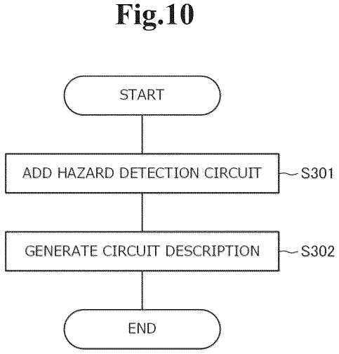

Next, an example of the configuration of a high-level synthesis apparatus 200 will be described with reference to FIGS. 8 to 10. FIG. 8 is a view showing an example of the hardware configuration of the high-level synthesis apparatus 200. FIG. 9 is a block diagram showing an example of the configuration of the high-level synthesis apparatus 200. FIG. 10 is a flowchart showing an example of the operation of the high-level synthesis apparatus 200.

In the second example embodiment of the present disclosure, the high-level synthesis apparatus 200 will be described that generates a circuit description in response to input of a behavioral description describing the behavior of a circuit. FIG. 8 shows an example of the hardware configuration of the high-level synthesis apparatus 200. Referring to FIG. 8, as an example, the high-level synthesis apparatus 200 has the following hardware configuration including:
a CPU (Central Processing Unit) 201 (arithmetic logic unit);
a ROM (Read Only Memory) 202 (memory unit);
a RAM (Random Access Memory) 203 (memory unit);
programs 204 loaded to the RAM 203;
a storage device 205 storing the programs 204;
a drive device 206 that reads from and writes into a recording medium 210 outside the information processing apparatus;
a communication interface 207 connected to a communication network 211 outside the information processing apparatus;
an input/output interface 208 that inputs and outputs data; and
a bus 209 that connects the respective components.

Further, the high-level synthesis apparatus 200 can realize functions as a hazard detection circuit adding unit 221 and a circuit description generating unit 222 shown in FIG. 9 by acquisition and execution of the programs 204 by the CPU 201. In addition, for example, the programs 204 are stored in advance in the storage device 205 or the ROM 202, and loaded to the RAM 203 or the like and executed by the CPU 201 as necessary. Moreover, the programs 204 may be provided to the CPU 201 via the communication network 211, or may be stored in advance in the recording medium 210 and read by the drive device 206 and provided to the CPU 201.

FIG. 8 shows an example of the hardware configuration of the high-level synthesis apparatus 200. The hardware configuration of the high-level synthesis apparatus 200 is not limited to the abovementioned case. For example, the high-level synthesis apparatus 200 may be configured with part of the abovementioned configuration, such as not having the drive device 206. Moreover, the CPU 201 may be a GPU or the like illustrated in the first example embodiment.

The hazard detection circuit adding unit 221 adds a hazard detection circuit that determines whether or not a hazard has occurred to a pipeline circuit generated in accordance with a behavioral description.

The circuit description generating unit 222 generates a circuit description that describes the pipeline circuit with the hazard detection circuit added by the hazard detection circuit adding unit 221.

The above is an example of the configuration of the high-level synthesis apparatus 200. Next, an example of the operation of the high-level synthesis apparatus 200 will be described with reference to FIG. 10.

Referring to FIG. 10, the hazard detection circuit adding unit 221 adds a hazard detection circuit that determines whether or not a hazard has occurred to a pipeline circuit generated in accordance with a behavioral description.

The circuit description generating unit 222 generates a circuit description that describes the pipeline circuit with the hazard detection circuit added by the hazard detection circuit adding unit 221.

The above is an example of the operation of the high-level synthesis apparatus 200.

Thus, the high-level synthesis apparatus 200 has the hazard detection circuit adding unit 221 and the circuit description generating unit 222. According to such a configuration, the circuit description generating unit 222 can generate a circuit description that describes the pipeline circuit with the hazard detection circuit added by the hazard detection circuit adding unit 221. As a result, it is possible to dynamically detect a hazard during a simulation and the like. Consequently, it is possible to realize proper hazard detection.

The abovementioned high-level synthesis apparatus 200 can be realized by installation of a predetermined program in an information processing apparatus such as the high-level synthesis apparatus 200. Specifically, a program as another aspect of the present disclosure is a program for causing an information processing apparatus such as the high-level synthesis apparatus 200 generating a circuit description in response to input of a behavioral description describing the behavior of a circuit to execute: adding a hazard detection circuit that determines whether or not a hazard has occurred to a pipeline circuit generated in accordance with a behavioral description; and generating a circuit description that describes the pipeline circuit with the hazard detection circuit added.

Further, a high-level synthesis method executed by an information processing apparatus such as the abovementioned high-level synthesis apparatus 200 is a method by an information processing apparatus generating a circuit description in response to input of a behavioral description describing the behavior of a circuit, including: adding a hazard detection circuit that determines whether or not a hazard has occurred to a pipeline circuit generated in accordance with a behavioral description; and generating a circuit description that describes the pipeline circuit with the hazard detection circuit added.

A program, a computer-readable recording medium on which a program is recorded, a high-level synthesis method or the like with the abovementioned configuration also produces the same action and effect as the abovementioned high-level synthesis apparatus 200, so that the abovementioned object of the present disclosure can be achieved.

### <Supplementary Notes>

The whole or part of the example embodiments disclosed above can be described as the following supplementary notes. Below, the overview of a high-level synthesis apparatus and so forth according to the present disclosure will be described. However, the present disclosure is not limited to the following configurations.

### (Supplementary Note 1)

A high-level synthesis apparatus generating a circuit description in response to input of a behavioral description describing a behavior of a circuit, the high-level synthesis apparatus comprising:
a hazard detection circuit adding unit that adds a hazard detection circuit determining presence or absence of occurrence of hazard to a pipeline circuit generated in accordance with the behavioral description; and
a circuit description generating unit that generates the circuit description describing the pipeline circuit with the hazard detection circuit added by the hazard detection circuit adding unit.

### (Supplementary Note 2)

The high-level synthesis apparatus according to Supplementary Note 1, wherein
the hazard detection circuit adding unit adds the hazard detection circuit to the pipeline circuit, the hazard detection circuit being a circuit dynamically determining presence or absence of hazard by comparison of element numbers at time of access between iterations.

### (Supplementary Note 3)

The high-level synthesis apparatus according to Supplementary Note 2, wherein
the hazard detection circuit detects occurrence of hazard in a case where, as a result of the comparison between the iterations, it is determined that read in a subsequent iteration is executed prior to write in a preceding iteration.

### (Supplementary Note 4)

The high-level synthesis apparatus according to any one of Supplementary Notes 1 to 3, wherein
the hazard detection circuit adding unit adds the hazard detection circuit to the pipeline circuit, the hazard detection circuit stopping a pipeline operation in response to detection of occurrence of hazard.

### (Supplementary Note 5)

The high-level synthesis apparatus according to Supplementary Note 4, wherein
the hazard detection circuit stalls whole execution of a subsequent iteration causing hazard and later iterations until array access of an iteration in which the hazard has been detected ends.

### (Supplementary Note 6)

The high-level synthesis apparatus according to any one of Supplementary Notes 1 to 5, wherein
the hazard detection circuit adding unit adds the hazard detection circuit to the pipeline circuit, the hazard detection circuit outputting a fact of detection of occurrence of hazard in response to the detection.

### (Supplementary Note 7)

A high-level synthesis method by an information processing apparatus generating a circuit description in response to input of a behavioral description describing a behavior of a circuit, the high-level synthesis method comprising:
adding a hazard detection circuit determining presence or absence of occurrence of hazard to a pipeline circuit generated in accordance with the behavioral description; and
generating the circuit description describing the pipeline circuit with the hazard detection circuit added.

### (Supplementary Note 8)

The high-level synthesis method according to Supplementary Note 7, comprising
when adding the hazard detection circuit, adding the hazard detection circuit to the pipeline circuit, the hazard detection circuit being a circuit dynamically determining presence or absence of hazard by comparison of element numbers at time of access between iterations.

### (Supplementary Note 9)

A computer program comprising instructions for causing an information processing apparatus, which generates a circuit description in response to input of a behavioral description describing a behavior of a circuit, to execute processes to:
add a hazard detection circuit determining presence or absence of occurrence of hazard to a pipeline circuit generated in accordance with the behavioral description; and
generate the circuit description describing the pipeline circuit with the hazard detection circuit added.

### (Supplementary Note 10)

The computer program according to Supplementary Note 9, the computer program comprising instructions for causing the information processing apparatus to execute processes to
when adding the hazard detection circuit, add the hazard detection circuit to the pipeline circuit, the hazard detection circuit being a circuit dynamically determining presence or absence of hazard by comparison of element numbers at time of access between iterations.

The whole or part of the configurations described in Supplementary Notes 2 to 6 that are dependent on the high-level synthesis apparatus described in Supplementary Note 1 may also be dependent on the high-level synthesis method described in Supplementary Note 7, the program described in Supplementary Note 9, and so forth, in the same dependent relation. Furthermore, without being limited to Supplementary Notes 7 and 9, within the scope of the above example embodiments, the whole or part of the configurations described as supplementary notes may be dependent on various hardware, software, various recording means for recording software, or systems.

The program described in the above example embodiments and supplementary notes is stored in a storage device or recorded on a computer-readable recording medium. For example, the recording medium is a portable medium such as a flexible disk, an optical disk, a magneto-optical disk, and a semiconductor memory.

Although the present disclosure has been described above with reference to the example embodiments, the present disclosure is not limited to the above example embodiments. The configuration and details of the present disclosure can be changed in various manners that can be understood by one skilled in the art within the scope of the present disclosure. Then, the respective example embodiments can be combined with the other example embodiment as necessary.

### DESCRIPTION OF REFERENCE NUMERALS

| | |
|---|---|
| 100 | high-level synthesis apparatus |
| 110 | operation input unit |
| 120 | screen display unit |
| 130 | communication I/F unit |
| 140 | storage unit |
| 141 | behavioral description information |
| 142 | circuit description information |
| 143 | program |
| 150 | operation processing unit |
| 151 | input analyzing unit |
| 152 | language converting unit |
| 153 | CDFG generating unit |
| 154 | scheduling unit |
| 155 | resource allocating unit |
| 156 | state transition diagram generating unit |
| 157 | pipelining unit |
| 158 | hazard detection circuit adding unit |
| 159 | circuit description generating unit |
| 200 | high-level synthesis apparatus |
| 201 | CPU |
| 202 | ROM |
| 203 | RAM |
| 204 | programs |
| 205 | storage device |
| 206 | drive device |
| 207 | communication interface |
| 208 | input/output interface |
| 209 | bus |
| 210 | recording medium |
| 211 | communication network |
| 221 | hazard detection circuit adding unit |
| 222 | circuit description generating unit |

1. A high-level synthesis apparatus generating a circuit description in response to input of a behavioral description describing a behavior of a circuit, the high-level synthesis apparatus comprising:
at least one memory storing processing instructions; and
at least one processor configured to execute the processing instructions to:
add a hazard detection circuit determining presence or absence of occurrence of hazard to a pipeline circuit generated in accordance with the behavioral description; and
generate the circuit description describing the pipeline circuit with the hazard detection circuit added by the hazard detection circuit adding unit.

2. The high-level synthesis apparatus according to claim 1, wherein the at least one processor is configured to execute the processing instructions to
add the hazard detection circuit to the pipeline circuit, the hazard detection circuit being a circuit dynamically determining presence or absence of hazard by comparison of element numbers at time of access between iterations.

3. The high-level synthesis apparatus according to claim 2, wherein the at least one processor is configured to execute the processing instructions to
detect occurrence of hazard in a case where, as a result of the comparison between the iterations, it is determined that read in a subsequent iteration is executed prior to write in a preceding iteration.

4. The high-level synthesis apparatus according to claim 1, wherein the at least one processor is configured to execute the processing instructions to
add the hazard detection circuit to the pipeline circuit, the hazard detection circuit stopping a pipeline operation in response to detection of occurrence of hazard.

5. The high-level synthesis apparatus according to claim 4, wherein the at least one processor is configured to execute the processing instructions to
stall whole execution of a subsequent iteration causing hazard and later iterations until array access of an iteration in which the hazard has been detected ends.

6. The high-level synthesis apparatus according to claim 1, wherein the at least one processor is configured to execute the processing instructions to
add the hazard detection circuit to the pipeline circuit, the hazard detection circuit outputting a fact of detection of occurrence of hazard in response to the detection.

7. A high-level synthesis method by an information processing apparatus generating a circuit description in response to input of a behavioral description describing a behavior of a circuit, the high-level synthesis method comprising:
adding a hazard detection circuit determining presence or absence of occurrence of hazard to a pipeline circuit generated in accordance with the behavioral description; and
generating the circuit description describing the pipeline circuit with the hazard detection circuit added.

8. The high-level synthesis method according to claim 7, comprising
when adding the hazard detection circuit, adding the hazard detection circuit to the pipeline circuit, the hazard detection circuit being a circuit dynamically determining presence or absence of hazard by comparison of element numbers at time of access between iterations.

9. A non-transitory computer-readable medium storing a program, the program comprising instructions for causing an information processing apparatus, which generates a circuit description in response to input of a behavioral description describing a behavior of a circuit, to execute processes to:
add a hazard detection circuit determining presence or absence of occurrence of hazard to a pipeline circuit generated in accordance with the behavioral description; and
generate the circuit description describing the pipeline circuit with the hazard detection circuit added.

10. The non-transitory computer-readable medium storing the program according to claim 9, the program comprising instructions for causing the information processing apparatus to execute processes to
when adding the hazard detection circuit, add the hazard detection circuit to the pipeline circuit, the hazard detection circuit being a circuit dynamically determining presence or absence of hazard by comparison of element numbers at time of access between iterations.
